(19) United States
(12) Patent Application Publication
(10) Pub. No.: US 2010/0269502 A1
(43) Pub. Date: Oct. 28, 2010

(54) External combustion engine

(76) Inventor: Edward Lawrence Warren, West Melbourne, FL (US)

Correspondence Address: Edward L. Warren, 3912 Snowy Egret Dr., West Melbourne, FL, 32904, US

(21) Appl. No.: 11/656,027

(22) Filed: Jan. 22, 2007

(51) Int. Cl. F03G 6/00; F01K 13/00; F01K 23/06

(52) U.S. Cl. 60/641.8; 60/645; 60/670

(57) ABSTRACT

In the “External Combustion Engine” fluid stored in a compressed fluid tank is released, and then heated by a synchronized heat exchanger. Heat is added at constant volume in a series of heaters and pre-heaters. The last heater is immediately above the power piston while the power piston is at the top of its stroke. Adiabatic expansion takes place and produces power output. Energy from the compressed fluid tank produces power output. Adiabatic expansion again takes place, and produces power output all the way to complete expansion. The spent fluid is exhausted through the heat exchanger, cooled, compressed, and stored in the compressed fluid tank. The pre-heaters heat all the fluid in the pre-heaters at constant volume and any number of pre-heaters can be used thereby providing unlimited time to transfer heat into the engine.

### BACKGROUND

1. Field of Invention

There is a need for a very efficient external combustion engine. The current favorite is the Stirling Engine. The problems with the Stirling Engines are they have heaters that need large heat transfer areas because the heat transfer time is a very small part of the complete cycle, and if they have large heat transfer areas they do not perform well. The “External Combustion Engine” overcomes that problem. It relates to a reciprocating, external combustion engine with a compressor, heat exchanger, synchronizer, heater, and expander.

2. Description of Prior Art

U.S. Pat. No. 7,140,182 to Warren (2006) does the following: 1. separates the compression from the expansion process, 2. compresses the air, 3. saves the exhaust heat and uses it to heat the compressed air, 4. stores the hot compressed air so that heat can be added at constant volume, 5. recovers the energy of the stored air, and 6. makes use of regenerative braking by compressing air into a storage tank.

What is needed is an external heat source instead of the internal one and a way to lengthen the time that heat from a heat source is applied to the compressed fluid. It would be good to heat the compressed fluid in such a way that the pressure rise from externally applied heat can be obtained at near constant volume with all the volume being heated, and to apply that pressure rise directly to the power piston.

The length of time the heat has to transfer through the metal walls of the heater to the compressed fluid needs to be longer. In the present machines, it is at most one stroke. It needs to be two or three strokes. The “External Combustion Engine” provides an unlimited number of strokes.

### SUMMARY

The present invention is U.S. Pat. No. 7,140,182 to Warren (2006) with a synchronizer, external heat source, and pre-heaters added. The result is an engine made up of a compressor, a heat exchanger, a synchronizer, one or more heat sources, one or more pre-heaters, a heater, and an expander. The heater and all pre-heaters are operated at constant volume with all the volume being heated. It can be run closed circuit with a compressed fluid storage tank, a cooler, and an expansion tank added.

### OBJECTS AND ADVANTAGES

The “External Combustion Engine” has the following advantages:

It operates on a very efficient regenerative thermodynamic cycle.

Heat can be added to the compressed fluid at almost constant volume with almost all of the volume being heated.

It can run closed circuit, and the circuit can be pressurized.

The size of the heaters or pre-heaters do not affect the efficiency of the engine.

Any number of pre-heaters can be added. The resultant time to transfer heat from the heat source to the fluid can be near infinite.

When running open cycle, when the load slows down the inertia work can be saved and reused.

### DRAWING FIGURES

FIG. 1 shows preferred embodiment of the invention at the end of the expansion stroke and the start of the exhaust stroke. Exhaust starts to move out of expansion cylinder 12, and compressed fluid starts to move out of compressed fluid storage tank 5.

FIG. 2 shows preferred embodiment of the invention at the end of the exhaust stroke. Compressed fluid starts to move out of second pre-heater 38 and into the volume below heater movable wall 11.

FIG. 3 shows preferred embodiment of the invention at the end of fluid moving into the volume below heater movable wall 11, and the start of the expansion stroke. Power piston 14 starts to move down generating power output.

FIG. 4 shows preferred embodiment of the invention after the pressure in compressed fluid storage tank 5 exceeded the pressure in expansion cylinder 12. Synchronizer movable wall 30 and heater movable wall 11 have moved down maintaining pressure on power piston 14. Power piston 14 will continue to move down.

FIG. 5 shows the first alternate embodiment of the invention operating open cycle.

FIG. 6 shows the second alternate embodiment of the invention at the end of the expansion stroke and the start of the exhaust stroke. It is the preferred embodiment without pre-heater module 34.

FIG. 7 shows the second alternate embodiment of the invention at the end of the exhaust stroke.

FIG. 8 shows the second alternate embodiment of the invention at the end of expander charging, and the start of the expansion stroke.

FIG. 9 shows the second alternate embodiment of the invention after the pressure in compressed fluid storage tank 5 exceeded the pressure in expansion cylinder 12.

FIG. 10 shows the third alternate embodiment of the invention at the end of the expansion stroke and the start of the exhaust stroke. It is the preferred embodiment operating open cycle without heat exchanger 6, synchronizer 10, cooler 58, or expansion tank 60.

FIG. 11 shows the third alternate embodiment of the invention at the end of the exhaust stroke, and the start of expander charging.

FIG. 12 shows the third alternate embodiment of the invention at the end of expander charging, and the start of the expansion stroke.

FIG. 13 shows the third alternate embodiment of the invention after the pressure in compressed fluid storage tank 5 exceeded the pressure in expansion cylinder 12.

### REFERENCE NUMERALS IN DRAWINGS

2 expander
3 fluid inlet
4 compressor
5 compressed fluid storage tank
6 heat exchanger
7 inlet valve
10 synchronizer
11 heater movable wall
12 expansion cylinder
13 first burner
14 power piston
15 pusher piston
16 second burner
17 exit valve
19 heater
21 load
22 tank exit valve
24 pusher piston connecting rod
26 power output shaft
28 power piston cam
29 power piston push rod
30 synchronizer movable wall
31 pusher piston connecting rod crank
32 exhaust exit
34 pre-heater module
35 synchronizer valve
36 first pre-heater
37 first pre-heater valve
38 second pre-heater
40 second pre-heater valve
42 pre-heater module movable wall
48 heater cam
50 heater push rod
54 heater rocker arm
56 synchronizer push rod
58 cooler
60 expansion tank

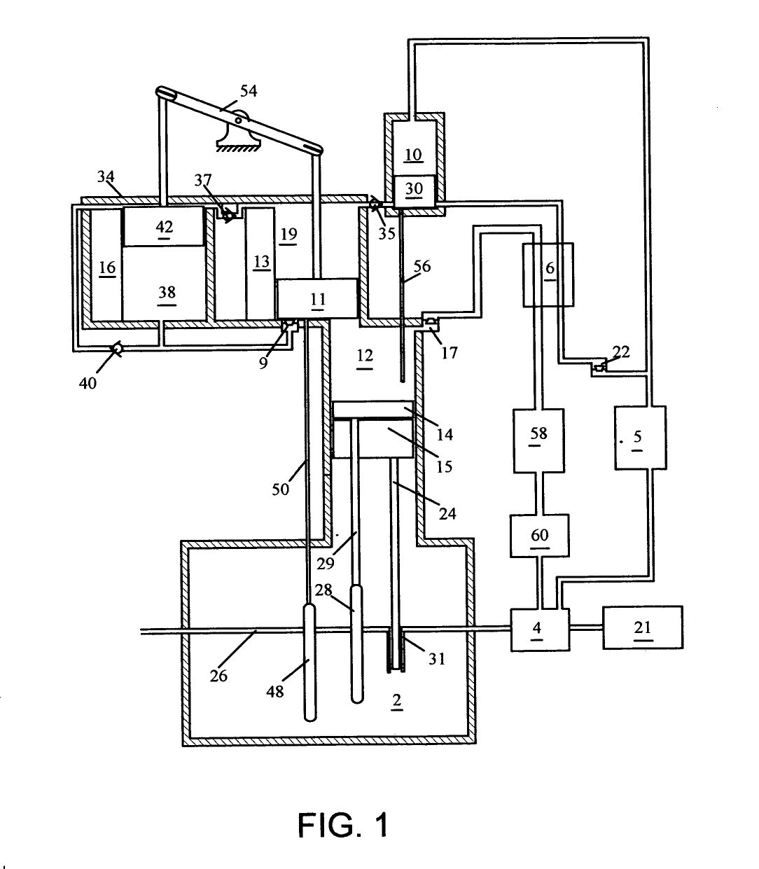

### Description—FIGS. 1-4—Preferred Embodiment

The preferred embodiment of this invention is the mechanization of a hot fluid engine cycle comprising compression, heat added from regeneration and energy stored, heat added from burner at nearly constant volume, close to adiabatic expansion, stored energy used, close to adiabatic expansion, heat rejected to regeneration.

The preferred embodiment of this invention is a pressurized closed cycle system with compressor 4, tank exit valve 22, compressed fluid storage tank 5, heat exchanger 6, synchronizer 10, expansion tank 60, expander 2, and pre-heater module 34. Synchronizer 10 contains synchronizer movable wall 30, which is moved up by the first mechanical means, synchronizer push rod 56. Expander 2 is comprised of heater 19, pre-heater module 34, and expansion cylinder 12. Heater 19 contains synchronizer valve 35, inlet valve 9, heater movable wall 11, and the first heating means of adding heat, first burner 13. Heater movable wall 11 is moved up by the second mechanical means, heater cam 48, and heater push rod 50. Expansion cylinder 12 is made up of power piston 14, pusher piston 15, pusher piston connecting rod crank 31, exit valve 17, pusher piston connecting rod 24, power output shaft 26, and the third mechanical means, power piston cam 28, and power piston push rod 29.

Pre-heater module 34 contains first pre-heater 36, first pre-heater valve 37, second pre-heater 38, pre-heater module movable wall 42 and second pre-heater valve 40, and the second means of adding heat, second burner 16. Pre-heater module movable wall 42 is moved up and down by a fourth mechanical means for moving pre-heater module movable wall 42, heater rocker arm 54. The space above pre-heater module movable wall 42 is first pre-heater 36. The space below pre-heater module movable wall 42 is second pre-heater 38.

Heat is added to heater 19 from first burner 13. Heat is added to first pre-heater 36 and to second pre-heater 38 from second burner 16.

Approximately constant volume heating is obtained by keeping power piston 14 close to the top of expansion cylinder 12 while the space under heater movable wall 11 fills with hot compressed fluid. The third mechanical means to move power piston 14 close to the top of the expansion cylinder 12 and keep it there until said pusher piston 15 moves to the top of its stroke is power piston push rod 29 and power piston cam 28. Power piston push rod 29 and power piston cam 28 move power piston 14 to the top of expansion cylinder 12 and keep it there until pusher piston 15 catches up. Pusher piston 15 is connected to pusher piston connecting rod 24 and pusher piston connecting rod crank 31 on power output shaft 26 that is connected to load 21 and compressor 4. Exit valve 17 allows fluid to exit expansion cylinder 12.

The engine has various ducts to conduct fluid between the various components.

The engine has only one each of compressor 4, compressed fluid storage tank 5, heat exchanger 6, cooler 58, and expansion tank 60, but it can have many synchronizers 10, and expanders 2. Each expander 2 can have many pre-heater modules 34.

Fluid flow control is shown using poppet type valves for inlet valve 9, tank exit valve 22, and exit valve 17 and check valves for synchronizer valve 35, first pre-heater valve 37, and second pre-heater valve 40. These could be replaced with other type flow control devices.

The fluid used in the engine can be any compressible fluid including but not limited to air.

First burner 13, and second burner 16 can be any of various heat sources such as burning fuel, exhaust from larger engine, geothermal heat, nuclear heat, or solar heat.

### Operation—FIGS. 1 to 4—Preferred Embodiment

In FIGS. 1 to 4 fluid is compressed in compressor 4, and stored in compressed fluid storage tank 5. Heat is added to the compressed fluid by heat exchanger 6. To synchronize the compressed fluid and the exhaust fluid so that they flow through the heat exchanger at the same time, synchronizer 10, synchronizer movable wall 30, and synchronizer push rod 56 are used.

FIG. 1 shows preferred embodiment of the invention at the end of the expansion stroke and the start of the exhaust stroke.

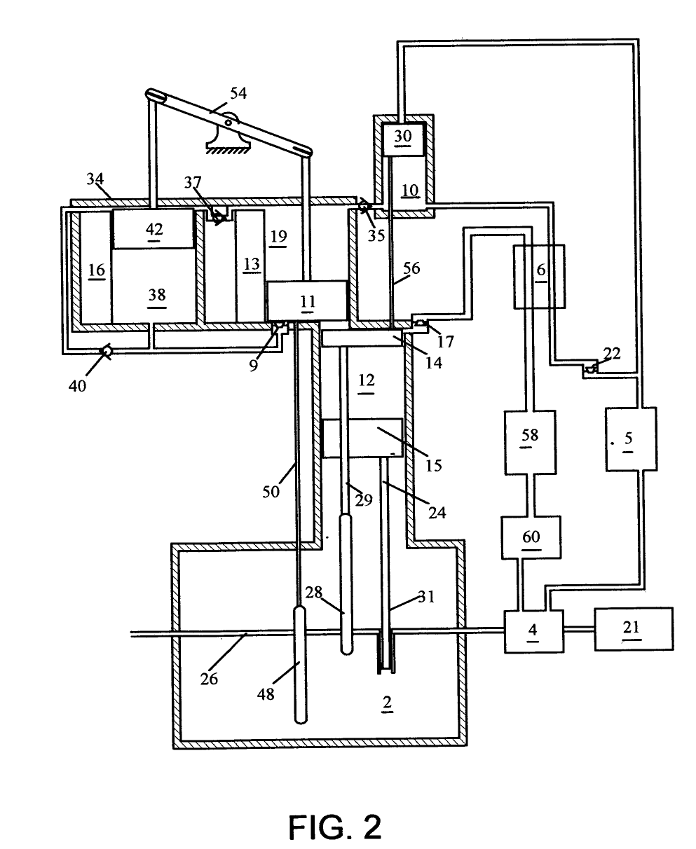

Between FIG. 1 and FIG. 2, exit valve 17 opens, power piston cam 28 and power piston push rod 29 push power piston 14 to the top of expansion cylinder 12 as pusher piston connecting rod crank 31 goes around its bottom travel and starts back up. When power piston 14 reaches the top of expansion cylinder 12 it is kept there by power piston cam 28 and power piston push rod 29. As power piston 14 moves up it forces the hot exhaust to move through exit valve 17, through heat exchanger 6, through cooler 58, through expansion tank 60, and through compressor 4 into compressed fluid storage tank 5. At the same time exit valve 17 opens, tank exit valve 22 opens and synchronizer movable wall 30 is pushed up by synchronizer push rod 56, fluid is moved from the space above synchronizer movable wall 30 through tank exit valve 22 through heat exchanger 6, to synchronizer 10 into the space below synchronizer movable wall 30.

In addition to heat exchanger 6, heat is also added to the compressed fluid at constant volume in heater 19 by first burner 13 and in second pre-heater 38 by second burner 16.

FIG. 2 shows preferred embodiment of the invention at the end of the exhaust stroke, and the start of expander 2 charging. Exit valve 17, has just closed.

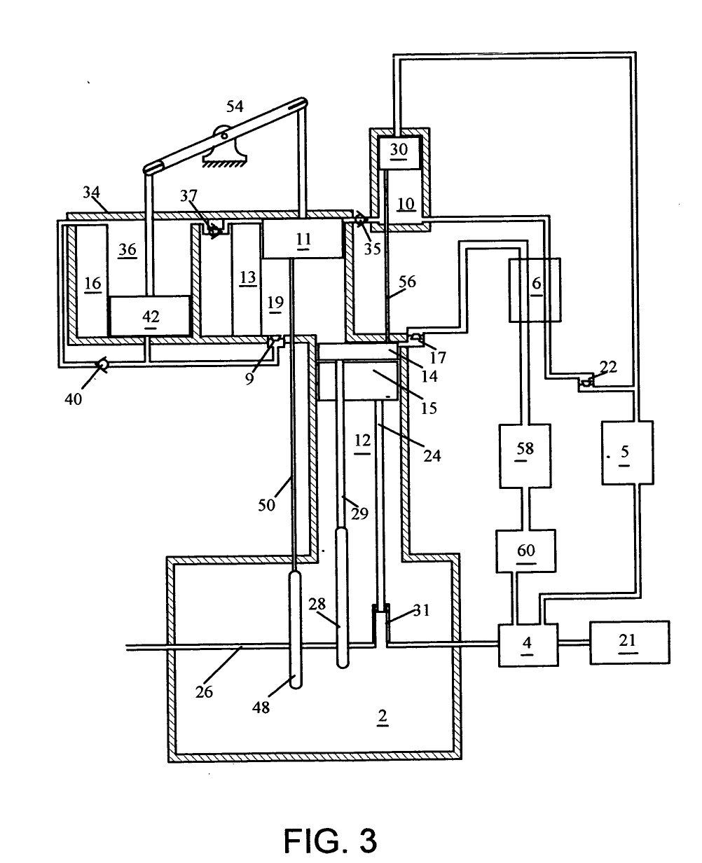

Between FIG. 2 and FIG. 3 inlet valve 9 opens, heater cam 48, and heater push rod 50, move heater movable wall 11 up and heater rocker arm 54 moves pre-heater module movable wall 42 down. As the pressures on the bottom and the top of heater movable wall 11 and on the bottom and the top of pre-heater module movable wall 42 are equal, heater movable wall 11 and pre-heater module movable wall 42 move easily and hot compressed fluid is pushed from on top heater movable wall 11 and enters first pre-heater 36, and hot compressed fluid is pushed from below pre-heater module movable wall 42 and enters heater 19 through inlet valve 9. Inlet valve 9 closes. Second burner 16 heats the fluid in first pre-heater 36 (shown in FIG. 3). Tank exit valve 22 closes.

FIG. 3 shows preferred embodiment of the invention at the end of expander 2 charging, and the start of the expansion stroke. Near top dead center of the travel of pusher piston 15, pusher piston 15 and power piston 14 come together. Power piston 14 starts to move down generating power output.

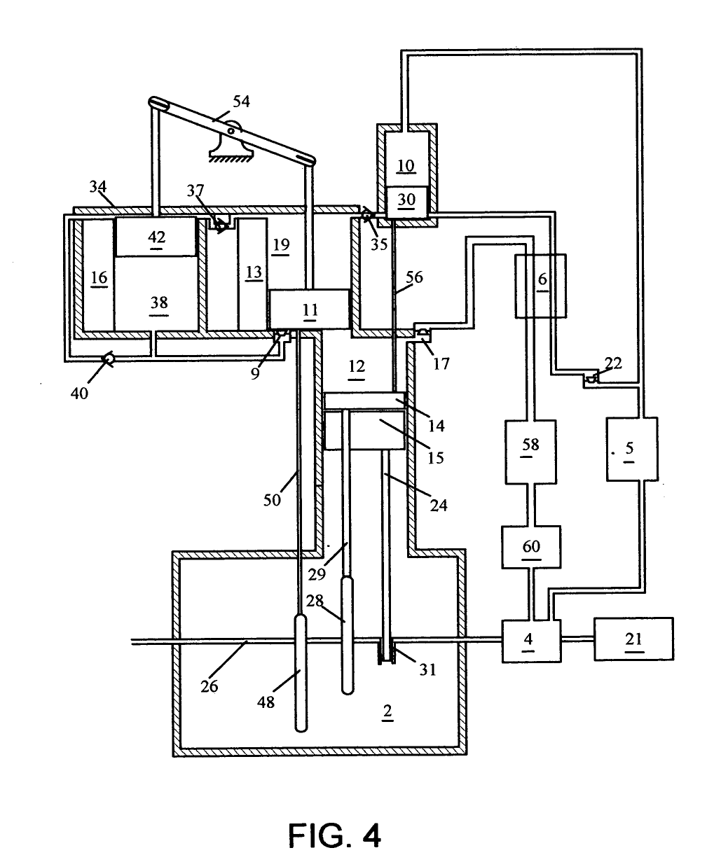

Between FIG. 3 and FIG. 4, first burner 13 continues to heat the fluid in heater 19 second burner 16 continues to heat the fluid in first pre-heater 36. The pressure in heater 19 and expansion cylinder 12 urges power piston 14 and pusher piston 15 along on their power output stroke. When power piston 14 is part way down on it's power output stroke, the force exerted by compressed fluid on the top of synchronizer movable wall 30 becomes greater than the pressure force on the bottom of heater movable wall 11. The stored energy in compressed fluid storage tank 5 is transferred through synchronizer 10, through heater 19 through the hot fluid mixture to power piston 14 and further urges power piston 14 down. Heater movable wall 11 moving down causes heater rocker arm 54 to move pre-heater module movable wall 42 up. When synchronizer movable wall 30 moves down, the fluid under synchronizer movable wall 30 moves into the space above heater movable wall 11, and when second pre-heater movable wall 42 moves up the fluid in first pre-heater 36 moves through second pre-heater valve 40 into second pre-heater 38.

FIG. 4 shows preferred embodiment of the invention after the pressure in compressed fluid storage tank 5 exceeds the pressure in expansion cylinder 12. Synchronizer movable wall 30 and heater movable wall 11 have moved down maintaining pressure on power piston 14.

Between FIG. 4 and FIG. 1 first burner 13 heats the fluid in heater 19 and second burner 16 heats the fluid in second pre-heater 38. The expanding mixture in expansion cylinder 12 continues urging power piston 14 downwards until exit valve 17 opens starting a new cycle.

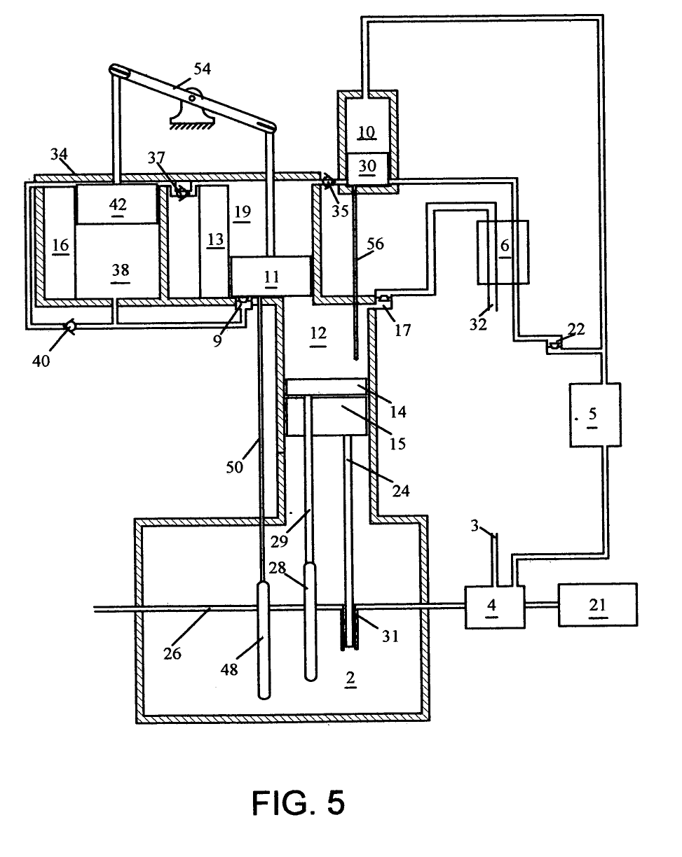

### Description—FIG. 5—First Alternate Embodiment

The first alternate embodiment of the invention is shown in FIG. 5. It is the preferred embodiment of the invention built to operate open cycle. Therefore, it has no cooler 58 or expansion tank 60.

### Operation—FIG. 5—First Alternate Embodiment

The operation of the first alternate embodiment of the invention (shown in FIG. 5.) is the same as the preferred embodiment of the invention except that the fluid is air, and it is exhausted to ambient and a new charge of air is brought into the compressor.

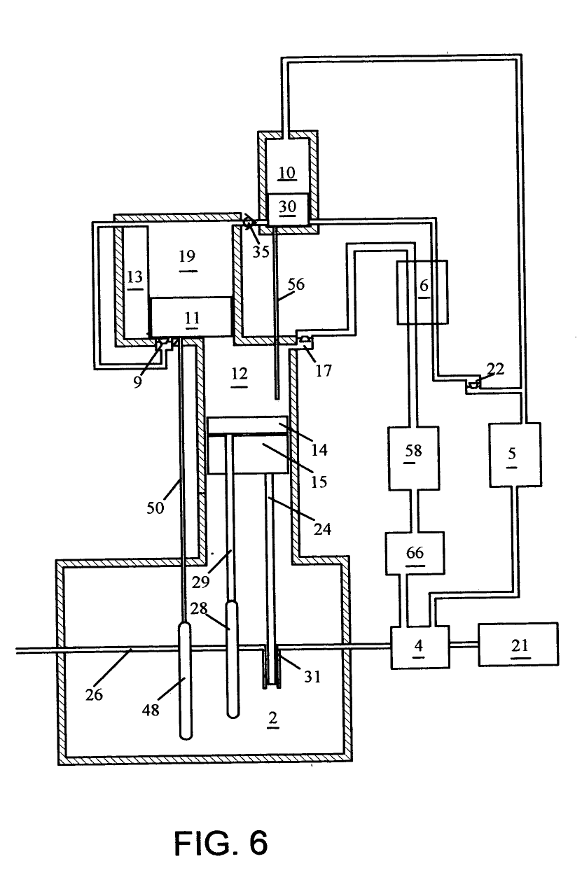

### Description—FIGS. 6-9—Second Alternate Embodiment

The second alternate embodiment of the invention is shown in FIGS. 6-9. It is the preferred embodiment of the invention without pre-heater module 34. The second alternate embodiment of the invention is a closed cycle system with compressor 4, tank exit valve 22, compressed fluid storage tank 5, heat exchanger 6, synchronizer 10, expansion tank 60, and expander 2, Synchronizer 10 contains synchronizer movable wall 30, which is moved up by the first mechanical means, synchronizer push rod 56. Expander 2 is comprised of heater 19, and expansion cylinder 12. Heater 19 contains synchronizer valve 35, inlet valve 9, heater movable wall 11, and the first heating means of adding heat, first burner 13. Heater movable wall 11 is moved up by the second mechanical means, heater cam 48, and heater push rod 50. Expansion cylinder 12 is made up of power piston 14, pusher piston 15, pusher piston connecting rod crank 31, exit valve 17, pusher piston connecting rod 24, power output shaft 26, and the third mechanical means, power piston cam 28, and power piston push rod 29.

Heat is added to heater 19 from first burner 13.

Approximately constant volume heating is obtained by keeping power piston 14 close to the top of expansion cylinder 12 while the space under heater movable wall 11 fills with hot compressed fluid. The third mechanical means to move power piston 14 close to the top of the expansion cylinder 12 and keep it there until said pusher piston 15 moves to the top of its stroke is power piston push rod 29 and power piston cam 28. Power piston push rod 29 and power piston cam 28 move power piston 14 to the top of expansion cylinder 12 and keep it there until pusher piston 15 catches up. Pusher piston 15 is connected to pusher piston connecting rod 24 and pusher piston connecting rod crank 31 on power output shaft 26 that is connected to load 21 and compressor 4. Exit valve 17 allows fluid to exit expansion cylinder 12.

The engine has various ducts to conduct fluid between the various components.

The engine has only one each of compressor 4, compressed fluid storage tank 5, heat exchanger 6, cooler 58, and expansion tank 60, but it can have many synchronizers 10, and expanders 2.

Fluid flow control is shown using poppet type valves for inlet valve 9, tank exit valve 22, and exit valve 17 and check valves for synchronizer valve 35. These could be replaced with other type flow control devices.

The fluid used in the engine can be any compressible fluid including but not limited to air.

First burner 13, can be any of various heat sources such as burning fuel, exhaust from larger engine, geothermal heat, nuclear heat, or solar heat.

### Operation—FIGS. 6 to 9—Second Alternate Embodiment

In FIGS. 6 to 9 fluid is compressed in compressor 4, and stored in compressed fluid storage tank 5. Heat is added to the compressed fluid by heat exchanger 6. To synchronize the compressed fluid and the exhaust fluid so that they flow through the heat exchanger at the same time, synchronizer 10, synchronizer movable wall 30, and synchronizer push rod 56 are used.

FIG. 6 shows second alternate embodiment of the invention at the end of the expansion stroke and the start of the exhaust stroke.

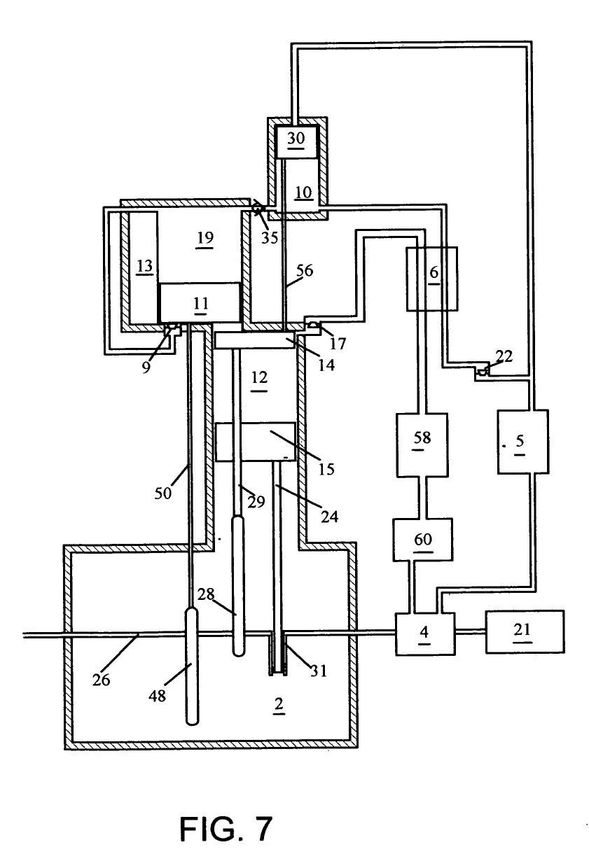

Between FIG. 6 and FIG. 7, exit valve 17 opens, power piston cam 28 and power piston push rod 29 push power piston 14 to the top of expansion cylinder 12 as pusher piston connecting rod crank 31 goes around its bottom travel and starts back up. When power piston 14 reaches the top of expansion cylinder 12 it is kept there by power piston cam 28 and power piston push rod 29. As power piston 14 moves up it forces the hot exhaust to move through exit valve 17, through heat exchanger 6, through cooler 58, through expansion tank 60, and through compressor 4 into compressed fluid storage tank 5. At the same time exit valve 17 opens, tank exit valve 22 opens and synchronizer movable wall 30 is pushed up by synchronizer push rod 56, fluid is moved from the space above synchronizer movable wall 30 through tank exit valve 22 through heat exchanger 6, to synchronizer 10 into the space below synchronizer movable wall 30.

In addition to heat exchanger 6, heat is also added to the compressed fluid at constant volume in heater 19 by first burner 13.

FIG. 7 shows second alternate embodiment of the invention at the end of the exhaust stroke, and the start of expander 2 charging. Exit valve 17, has just closed and inlet valve 9 has just opened.

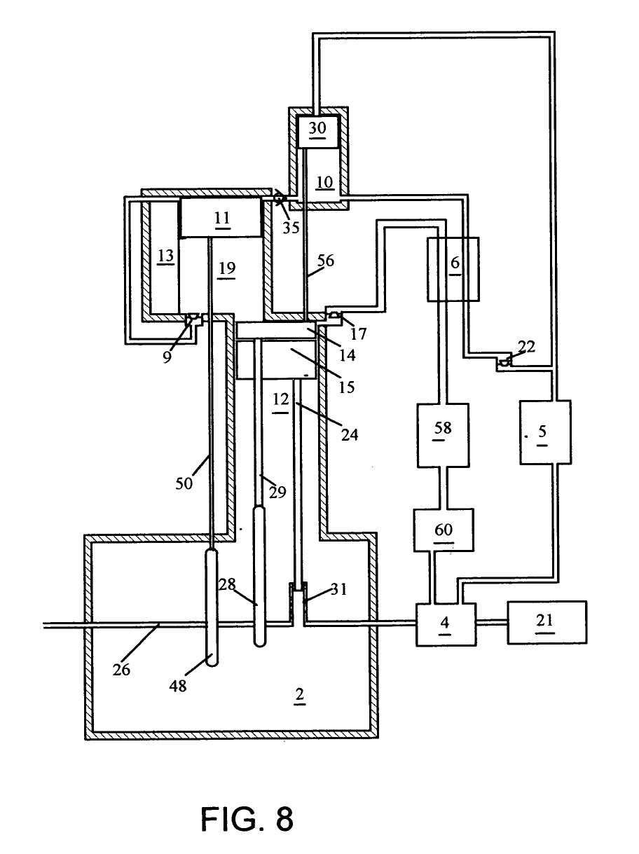

Between FIG. 7 and FIG. 8 heater cam 48, and heater push rod 50 move heater movable wall 11 up. As the pressures on the bottom and the top of heater movable wall 11 are equal, heater movable wall 11 moves easily and hot compressed fluid is pushed from on top heater movable wall 11 through inlet valve 9 into the space below heater movable wall 11. Inlet valve 9 closes. Tank exit valve 22 closes.

FIG. 8 shows second alternate embodiment of the invention at the end of expander 2 charging, and the start of the expansion stroke. Near top dead center of the travel of pusher piston 15, pusher piston 15 and power piston 14 come together. Power piston 14 starts to move down generating power output.

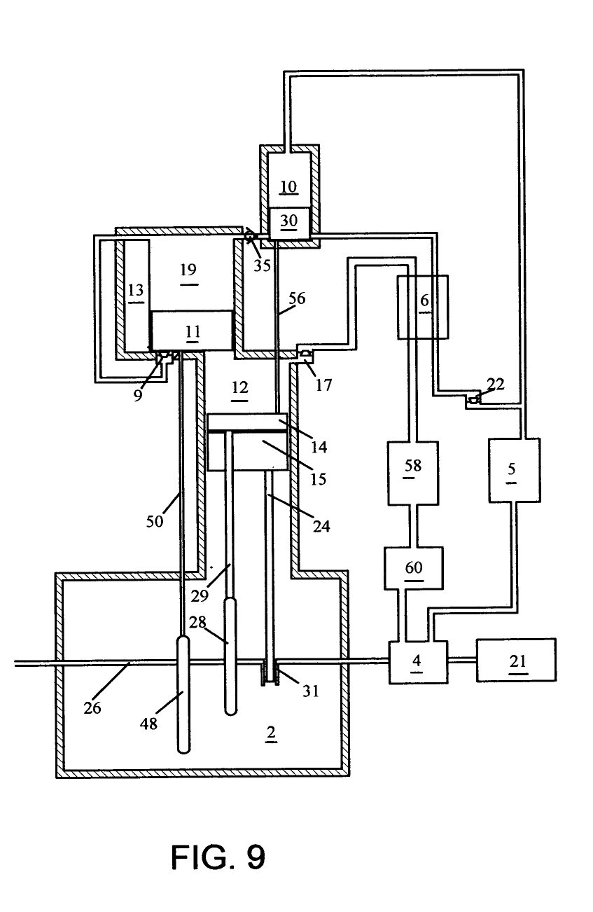

Between FIG. 8 and FIG. 9 The pressure in heater 19 and expansion cylinder 12 urges power piston 14 and pusher piston 15 along on their power output stroke. When power piston 14 is part way down on it's power output stroke, the force exerted by compressed fluid on the top of synchronizer movable wall 30 becomes greater than the pressure force on the bottom of heater movable wall 11. The stored energy in compressed fluid storage tank 5 is transferred through synchronizer 10, through heater 19 through the hot fluid mixture to power piston 14 and further urges power piston 14 down. When synchronizer movable wall 30 moves down, the fluid under synchronizer movable wall 30 moves into the space above heater movable wall 11.

FIG. 9 shows second alternate embodiment of the invention after the pressure in compressed fluid storage tank 5 exceeds the pressure in expansion cylinder 12. Synchronizer movable wall 30 and heater movable wall 11 have moved down maintaining pressure on power piston 14.

Between FIG. 9 and FIG. 6 first burner 13 heats the fluid in heater 19. The expanding mixture in expansion cylinder 12 continues urging power piston 14 downwards until exit valve 17 opens starting a new cycle.

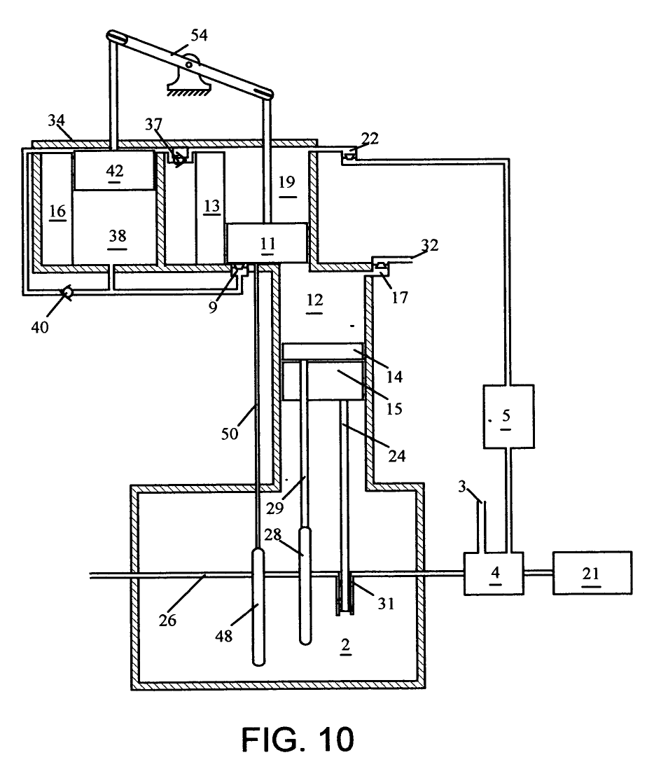

### Description—FIGS. 10-13—Third Alternate Embodiment

The third alternate embodiment of this invention is the mechanization of a hot air engine cycle comprising compression, heat added from burner at nearly constant volume, close to adiabatic expansion, compressed fluid energy used, close to adiabatic expansion, heat rejected to regeneration.

The third alternate embodiment of this invention is an open cycle system with compressor 4, tank exit valve 22, compressed fluid storage tank 5, expander 2, and pre-heater module 34. Expander 2 is comprised of heater 19, pre-heater module 34, and expansion cylinder 12. Heater 19 contains inlet valve 9, and heater movable wall 11 and the first heating means of adding heat, first burner 13. Heater movable wall 11 is moved up by the second mechanical means, heater cam 48, and heater push rod 50. Expansion cylinder 12 is made up of power piston 14, pusher piston 15, pusher piston connecting rod crank 31, exit valve 17, pusher piston connecting rod 24, power output shaft 26, and the third mechanical means, power piston cam 28, and power piston push rod 29.

Pre-heater module 34 contains first pre-heater 36, first pre-heater valve 37, second pre-heater 38, pre-heater module movable wall 42 and second pre-heater valve 40. Pre-heater module movable wall 42 is moved up and down by the fourth mechanical mean for moving said pre-heater module movable wall 42, heater rocker arm 54. The space above pre-heater module movable wall 42 is first pre-heater 36. The space below pre-heater module movable wall 42 is second pre-heater 38.

Heat is added to heater 19 from first burner 13. Heat is added to first pre-heater 36 and to second pre-heater 38 from second burner 16. First burner 13 is the first heating means and second burner 16 is the second heating means.

Approximately constant volume heating is obtained by keeping power piston 14 close to the top of expansion cylinder 12 while the space under heater movable wall 11 fills with hot compressed fluid. The mechanical means to move power piston 14 close to the top of the expansion cylinder 12 and keep it there until said pusher piston 15 moves to the top of its stroke is power piston push rod 29 and power piston cam 28. Power piston push rod 29 and power piston cam 28 move power piston 14 to the top of expansion cylinder 12 and keep it there until pusher piston 15 catches up. Pusher piston 15 is connected to pusher piston connecting rod 24 and pusher piston connecting rod crank 31 on power output shaft 26 that is connected to load 21 and compressor 4. Exit valve 17 allows fluid to exit expansion cylinder 12.

The engine has various ducts to conduct fluid between the various components.

The engine has only one each of compressor 4, compressed fluid storage tank 5, but it can have many expanders 2. Each expander 2 can have many pre-heater modules 34.

Fluid flow control is shown using poppet type valves for inlet valve 9, tank exit valve 22, and exit valve 17 and check valves for first pre-heater valve 37, and second pre-heater valve 40. These could be replaced with other type flow control devices.

The fluid used in the engine is air.

First burner 13, and second burner 16 can be any of various heat sources such as burning fuel, exhaust from larger engine, geothermal heat, nuclear heat, or solar heat.

### Operation—FIGS. 10 to 13—Third Alternate Embodiment

In FIGS. 10 to 13 fluid is compressed in compressor 4, and stored in compressed fluid storage tank 5.

FIG. 10 shows Third Alternate embodiment of the invention at the end of the expansion stroke and the start of the exhaust stroke.

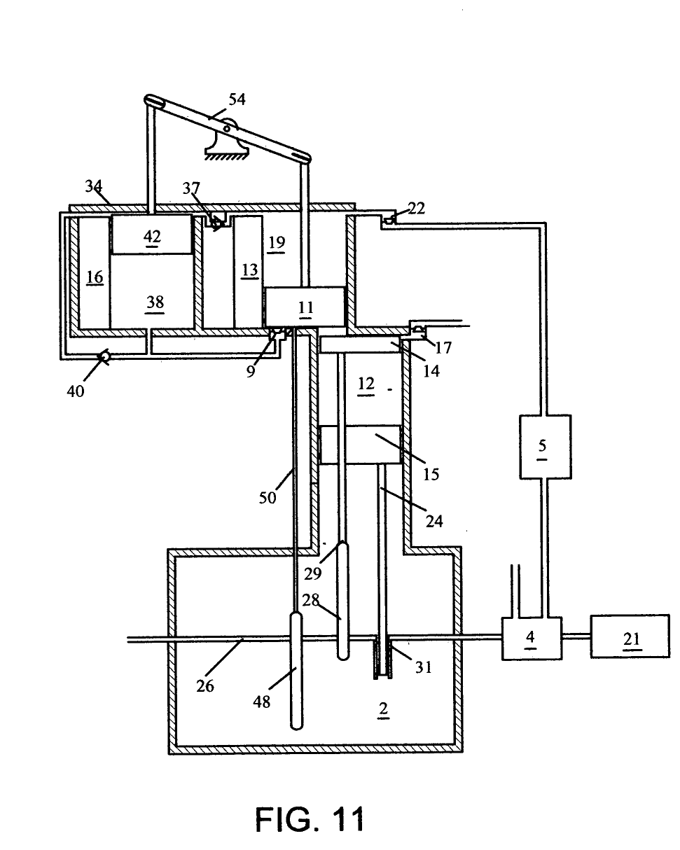

Between FIG. 10 and FIG. 11, exit valve 17 opens, power piston cam 28 and power piston push rod 29 push power piston 14 to the top of expansion cylinder 12 as pusher piston connecting rod crank 31 goes around its bottom travel and starts back up. When power piston 14 reaches the top of expansion cylinder 12 it is kept there by power piston cam 28 and power piston push rod 29. As power piston 14 moves up it forces the hot exhaust to move through exit valve 17. At the same time exit valve 17 opens, tank exit valve 22 opens and fluid is moved into heater 19 into the space above heater movable wall 11.

Heat is added to the compressed fluid at constant volume in heater 19 by first burner 13 and in second pre-heater 38 by second burner 16.

FIG. 11 shows first alternate embodiment of the invention at the end of the exhaust stroke, and the start of expander 2 charging. Exit valve 17, has just closed.

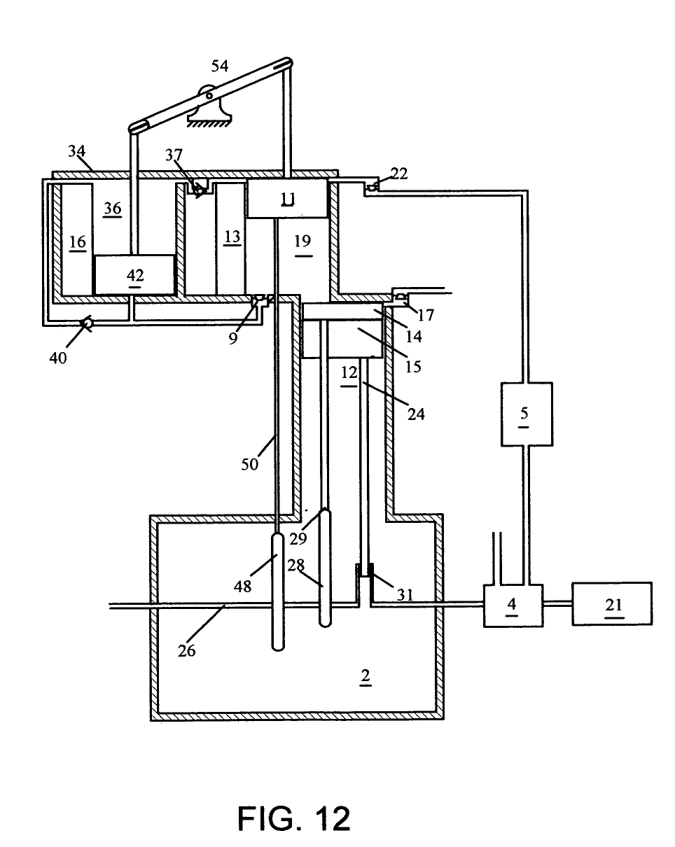

Between FIG. 11 and FIG. 12 inlet valve 9 opens, heater cam 48, heater push rod 50, and heater rocker arm 54 move heater movable wall 11 up and pre-heater module movable wall 42 down. As the pressures on the bottom and the top of heater movable wall 11 and on the bottom and the top of pre-heater module movable wall 42 are equal, heater movable wall 11 and pre-heater module movable wall 42 move easily and hot compressed fluid is pushed from on top heater movable wall 11 and enters first pre-heater 36, and hot compressed fluid is pushed from below pre-heater module movable wall 42 and enters heater 19 through inlet valve 9. Inlet valve 9 closes. Second burner 16 heats the fluid in first pre-heater 36 (shown in FIG. 12). Tank exit valve 22 closes.

FIG. 12 shows third Alternate embodiment of the invention at the end of expander 2 charging, and the start of the expansion stroke. Near top dead center of the travel of pusher piston 15, pusher piston 15 and power piston 14 come together. Power piston 14 starts to move down generating power output.

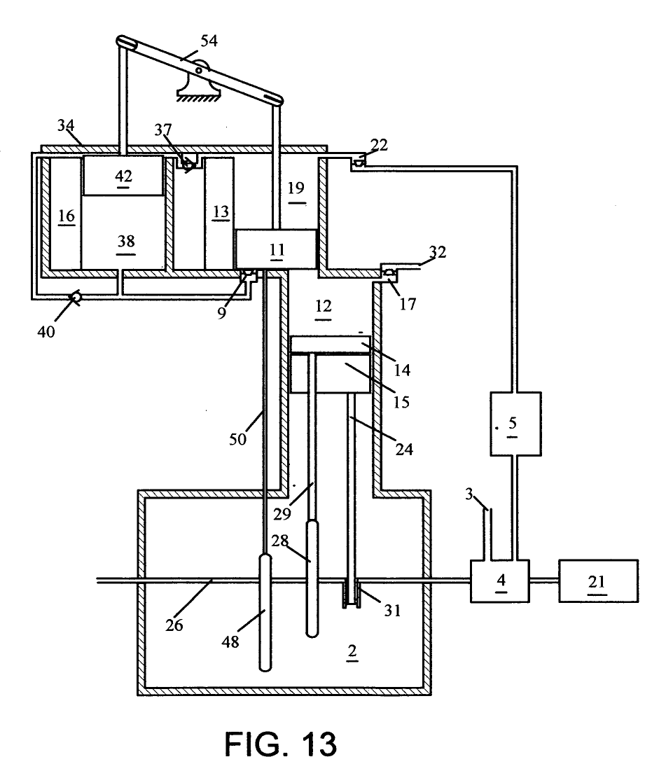

Between FIG. 12 and FIG. 13 first burner 13 continues to heat the fluid in heater 19 and second burner 16 continues to heat the fluid in first pre-heater 36. The pressure in heater 19 and expansion cylinder 12 urges power piston 14 and pusher piston 15 along on their power output stroke. When power piston 14 is part way down on it's power output stroke, the force exerted by compressed fluid on the top of movable wall 11 becomes greater than the pressure force on the bottom of heater movable wall 11. The stored energy in compressed fluid storage tank 5 is transferred through heater 19 through the hot fluid mixture to power piston 14 and further urges power piston 14 down. Heater movable wall 11 moving down causes heater rocker arm 54 to move pre-heater module movable wall 42 up. When second pre-heater movable wall 42 moves up the fluid in first pre-heater 36 moves through second pre-heater valve 40 into second pre-heater 38.

FIG. 13 shows third alternate embodiment of the invention after the pressure in compressed fluid storage tank 5 exceeds the pressure in expansion cylinder 12. heater movable wall 11 has moved down maintaining pressure on power piston 14.

Between FIG. 13 and FIG. 10 first burner 13 heats the fluid in heater 19 and second burner 16 heats the fluid in second pre-heater 38. The expanding mixture in expansion cylinder 12 continues urging power piston 14 downwards until exit valve 17 opens starting a new cycle.

### CONCLUSION

The “External Combustion Engine” has the following advantages:

It is very efficient.

Heat is added at constant volume

It can run closed circuit, and the circuit can be pressurized.

It can use large heaters

Heat transfer time can be near infinite.

I claim:

1. A method of operating an external combustion engine, said engine comprising a compressor, a compressed fluid storage tank, tank exit valve, a heat exchanger, a cooler, a load, a power output shaft for attaching said compressor and said load, one or more synchronizer and expander pairs, each synchronizer comprising:
a) synchronizer valve;
b) a synchronizer movable wall inside said synchronizer with the space above said synchronizer movable wall connected to compressed fluid from said compressed fluid storage tank, and a space below said synchronizer movable wall connected between said heat exchanger and said synchronizer valve;
c) a first mechanical means to move said synchronizer movable wall up; and each expander comprising:
d) a heater;
e) a heater movable wall inside said heater with the space above said movable wall connected through said synchronizer valve to said synchronizer; said synchronizer valve keeps compressed fluid from said synchronizer from flowing back into said synchronizer;
f) a first heating means for increasing the heat in said heater;
g) an inlet valve to allow compressed fluid into the space below said heater movable wall;
h) a second mechanical means for moving said heater movable wall away from said inlet valve when said inlet valve is open;
i) a expansion cylinder, with said heater at one end;
j) a power piston in said expansion cylinder which moves in a reciprocating manner;
k) a pusher piston in said expansion cylinder which moves in a reciprocating manner and transfers pressure forces on said power piston to said power output shaft;
l) a third mechanical means for moving said power piston near the heater end of said expansion cylinder and keeping said power piston at the heater end of said expansion cylinder until said pusher piston moves to the top of its stroke in said expansion cylinder;
m) an exit valve.
said method of operating said external combustion engine comprising the steps of:
compressing fluid;
storing said fluid in said compressed fluid storage tank;
regenerating exhaust heat from exhaust gases;
transferring said exhaust heat to the compressed fluid;
further heating said compressed fluid at near constant volume;
expanding the heated compressed fluid at near adiabatic conditions;
using the stored energy of said compressed fluid storage tank;
expanding said heated compressed fluid at near adiabatic conditions;
exhausting said expansion cylinder through said exit valve; and
rejecting heat to ambient.

2. An engine comprising a compressor, a compressed fluid storage tank, tank exit valve, a load, a power output shaft for attaching said compressor and said load, one or more expanders, each expander comprising:
a) a heater;
b) a heater movable wall inside said heater with the space above said movable wall connected through said tank exit valve to said compressed fluid storage tank;
c) a first heating means for increasing the heat in said heater;
d) an inlet valve to allow compressed fluid into the space below said heater movable wall;
e) a second mechanical means for moving said heater movable wall away from said inlet valve when said inlet valve is open;
f) a expansion cylinder, with said heater at one end;
g) a power piston in said expansion cylinder which moves in a reciprocating manner;
h) a pusher piston in said expansion cylinder which moves in a reciprocating manner and transfers pressure forces on said power piston to said power output shaft;
i) a third mechanical means for moving said power piston near the heater end of said expansion cylinder and keeping said power piston at the heater end of said expansion cylinder until said pusher piston moves to the top of its stroke in said expansion cylinder;
j) an exit valve.

3. The external combustion engine of claim 2 wherein said first heating means for increasing the heat in said heater is a first burner.

4. The external combustion engine of claim 2 wherein said first heating means for increasing the heat in said heater is a solar heater.

5. The external combustion engine of claim 2 wherein said first heating means for increasing the heat in said heater is a nuclear heat source.

6. The external combustion engine of claim 2 wherein said first heating means for increasing the heat in said heater is the exhaust from a hotter engine.

7. The external combustion engine of claim 2 wherein said second mechanical means for moving said heater movable wall up is a heater push rod moved by a heater cam on said power output shaft.

8. The external combustion engine of claim 2 wherein said third mechanical means for moving said power piston to near the heater end of said expansion cylinder, and keeping said piston at the heater end of said expansion cylinder until said pusher piston moves to the top of its stroke in said expansion cylinder is a power piston push rod moved by a power piston cam on said power output shaft.

9. The external combustion engine of claim 2 further comprising one or more pre-heater modules. Each pre-heater modules comprising:
a) first pre-heater;
b) first pre-heater valve;
c) second pre-heater;
d) second pre-heater valve;
e) a second heating means for increasing the heat in said heater;
f) pre-heater module movable wall;
g) a fourth mechanical means for moving said pre-heater module movable wall.

10. The external combustion engine of claim 9 wherein said fourth mechanical means for moving said pre-heater module movable wall is a heater rocker arm.

11. The external combustion engine of claim 9 wherein said first heating means for increasing the heat in said heater is a second burner.

12. The external combustion engine of claim 9 wherein said second heating means for increasing the heat in said heater is a solar heater.

13. The external combustion engine of claim 9 wherein said second heating means for increasing the heat in said heater is a nuclear heat source.

14. The external combustion engine of claim 9 wherein said second heating means for increasing the heat in said heater is the exhaust from a hotter engine.

15. The external combustion engine of claim 2 further comprising a heat exchanger, cooler, one or more synchronizers each synchronizer comprising:
a) synchronizer valve;
b) a synchronizer movable wall inside said synchronizer with the space above said synchronizer movable wall connected to said compressed fluid storage tank, and a space below said synchronizer movable wall connected between said heat exchanger and said synchronizer valve;
c) a first mechanical means to move said synchronizer movable wall up;

16. The external combustion engine of claim 15 wherein said first mechanical means for moving said synchronizer movable wall up is a synchronizer push rod attached to said synchronizer movable wall, and extending towards said power piston.

17. The external combustion engine of claim 15 wherein the exit of said cooler is connected to the inlet of said compressor.

18. The external combustion engine of claim 17 wherein the fluid is air with a minimum pressure greater than ambient.

19. The external combustion engine of claim 17 wherein the exit of said cooler is connected to the inlet of said compressor through an expansion tank.
